(19) United States
(12) Patent Application Publication
(10) Pub. No.: US 2003/0232897 A1
(43) Pub. Date: Dec. 18, 2003

(54) Process for producing activated graphitic foam with high surface area

(76) Inventors: Dennis M. Pfister, San Luis Obispo, CA (US); Charles M. Byrd, Rensselaer, NY (US)

Correspondence Address: Henry C. Query, Jr., 504 S. Pierce Avenue, Wheaton, IL, 60187, US

(21) Appl. No.: 10/174,838

(22) Filed: Jun. 18, 2002

(51) Int. Cl. C01B 31/00

(52) U.S. Cl. 521/142; 264/29.6; 264/51; 423/445 R

(57) ABSTRACT

A process for producing graphitic foam comprises mixing a first amount of an activated first carbon precursor with a second amount of a second carbon precursor, heating the mixture of the activated first and the second carbon precursors to a temperature sufficient to coalesce the mixture into a liquid, foaming the mixture, heating the foam under an inert atmosphere to a temperature and for a length of time sufficient to carbonize the foam, and heating the carbonized foam under an inert atmosphere to a temperature and for a length of time sufficient to graphitize the foam.

### BACKGROUND OF THE INVENTION

The present invention is directed to an activated graphitic foam product which has a relatively large specific surface area, high thermal conductivity and superior mechanical strength, and, more particularly, to a process for producing such a foam product.

Due to their large specific surface areas and high thermal conductivities, activated graphitic foam products are particularly useful in adsorption and thermal management applications which require the removal of significant amounts of heat. For example, activated graphitic foams made from mesophase homopolymer pitch precursors commonly have thermal conductivities higher than many aluminum alloys. In practice, therefore, devices made from these foams have superior performance, capacity and efficiency.

Graphitic foams are commonly produced using a blowing technique in which a pitch precursor is melted under high pressure and then allowed to expand to a lower pressure. The expansion to the lower pressure causes the low molecular weight compounds in the pitch to vaporize, which results in the foaming of the pitch. The pitch foam is then stabilized by heating it in air or oxygen for several hours to cross-link the structure and thereby set the pitch. The stabilized pitch foam is then carbonized by heating it in an inert atmosphere to temperatures of up to about 1100° C. Finally, the carbonized foam is graphitized by heating it in an inert atmosphere to temperatures of up to about 3000° C.

The specific surface area, and thus the adsorption capacity, of a graphitic foam can be greatly increased by activating the foam. In conventional activation methods, pores are formed as a result of carbon elimination caused by the reaction of, for example, water vapor or carbon dioxide with the carbon sites in the foam. However, this activation technique typically only works on foams made from hard carbon materials, such as coconut shell, coal and phenol resin, and these materials are generally not suitable precursors for applications requiring high thermal conductivities.

Rather, mesophase homopolymer precursors are generally preferred for producing graphitic foams having high thermal conductivities. However, these materials tend to crystallize when heated and are therefore not easily activated using conventional techniques. Instead, such soft carbon materials must typically be activated with an alkali metal such as potassium hydroxide (KOH). In this process, the graphitic foam is soaked in a solution of KOH, heated to about 500° C. or higher in an inert atmosphere, allowed to cool, and then rinsed to remove the KOH. However, proper activation using this technique often results in a loss of 80% or more of the foam material, and this can significantly reduce the mechanical integrity of the foam. In addition, maintaining high concentrations of KOH in the interior of the foam during the activation process is often quite difficult. Furthermore, rinsing the KOH from the foam after the activation process usually requires sophisticated techniques, such as high temperature vacuum removal.

### SUMMARY OF THE INVENTION

In accordance with the present invention, these and other limitations in the prior art are overcome by pre-activating a portion of the carbon precursor prior to producing the foam. Thus, the process of the present invention comprises the steps of mixing a first amount of an activated first carbon precursor with a second amount of a second carbon precursor, heating the mixture of the first and second carbon precursors to a temperature sufficient to coalesce the mixture, foaming the mixture, heating the foam under an inert atmosphere to a temperature and for a length of time sufficient to carbonize the foam, and heating the carbonized foam under an inert atmosphere to a temperature and for a length of time sufficient to graphitize the foam.

In accordance with one embodiment of the invention, the activated first carbon precursor comprises activated mesophase pitch particles. In addition, the second carbon precursor comprises un-activated particles of the same mesophase pitch. Moreover, the first and second amounts of such particles each comprises about fifty percent by weight of the total mixture of the particles.

In accordance with another embodiment of the invention, the foaming step is accomplished by placing the mixture of the first and second carbon precursors in a sealed container and then heating the mixture to a temperature sufficient to coalesce the mixture into a liquid state. The vacuum is then released and an inert gas is introduced to pressurize the container to up to about 1000 psi. The mixture is then gradually heated under pressure to a temperature sufficient to coke the mixture, which depending on the carbon precursor could be between about 500° C. and 1000° C. As the temperature of the mixture rises through a specific range, for example 400° to 500° C., the volatile gases within the mixture will evolve, that is, boil off, and foam the molten mixture. Further heating of the foamed mixture will then coke the foam and thus produce a solid foam product. The foam is then allowed to gradually cool to room temperature while the pressure within the container is slowly reduced to atmospheric pressure. The foam is then heated under an inert atmosphere to a temperature sufficient to carbonize the foam, and then, if desired, further heated under an inert atmosphere to a temperature sufficient to graphitize the foam.

The present invention produces a graphitic foam product having a specific surface area that is comparable to an activated graphitic foam product, but without the need to activate the foam. Consequently, the time and materials required to activate the foam are eliminated. Moreover, the mass and structural integrity of the foam are not reduced during an activation process.

These and other advantages of the present invention will be made apparent from the following detailed description.

### DETAILED DESCRIPTION OF THE PREFERRED EMBODIMENTS

The process of the present invention can be used to produce carbon and graphitic foam products which have relatively high specific surface areas and superior mechanical strength. As such, these foam products are particularly useful in adsorption and thermal management applications which require the removal of a large amount of heat in a relatively short period of time. However, the carbon and graphitic foam products of the present invention are also useful in applications in which high thermal conductivity is not of primary importance.

The first step of the present invention involves mixing a first amount of an activated first carbon precursor with a second amount of a second carbon precursor. The first carbon precursor may be any pitch-based or PAN-based material which is suitable for making carbon foams. In applications where high thermal conductivity is required of the foam, however, the first carbon precursor is preferably an organic or synthetic mesophase pitch. For example, a suitable first carbon precursor for use in thermal management applications is AR synthesized mesophase pitch, which is manufactured by Mitsubishi Gas Chemical Company, Inc. of Tokyo, Japan.

The first carbon precursor may be supplied in fiber, pellet or particulate form. However, prior to mixing with the second carbon precursor, the first carbon precursor is milled using conventional techniques into particles or fibers having a suitably small mean diameter. For example, the first carbon precursor may be milled into particles or fibers having a mean diameter of roughly 25 micrometers. For purposes of this application, the terms “particles” and “fibers” will be used interchangeably.

Prior to mixing with the second carbon precursor, the first carbon precursor particles are activated using a conventional activation technique. In applications requiring a foam product having a relatively high thermal conductivity, the activation technique should optimally yield first carbon precursor particles having a BET specific surface area of greater than about 200 m²/g. As an alternative to activating the first carbon precursor particles, pre-activated particles may be obtained from an appropriate supplier. For example, suitable pre-activated mesophase pitch particles having a mean diameter of about 25 micrometers and a BET specific surface area of approximately 300 m²/g may be obtained from Petoca, Ltd. of Tokyo, Japan. Also, suitable pre-activated carbon fibers having a mean diameter of around 20 Angstroms and a BET specific surface area of about 2,600 m²/g can be obtained from Carbon Resources, LLC of Huntington Beach, Calif. under the product name Sabre Series ACF-130-2600. Moreover, the size of the pre-activated particles or fibers may be precisely controlled by grinding.

The activated first carbon precursor particles can also be made according to the method described in U.S. Pat. No. 6,118,650, which is hereby incorporated herein by reference. As taught in this patent, a mesophase pitch precursor is spun into fibers using a conventional spinning method, such as the melt blow method. A suitable pitch precursor for this process is an optically anisotropic pitch having a Mettler softening point of around 285° C. and a mesophase content of 100%, such as the Mitsubishi AR mesophase pitch mentioned above. Since the mesophase pitch is a thermoplastic organic compound, the fibers are preferably infusibilized so that they will retain their shape during subsequent heat treatments. The fibers may be infusibilized by heating them in air at an average rate of 1° to 15° C. per minute to a temperature of between about 100° C. to 350° C. The infusibilized fibers are then ideally subjected to a slight carbonization treatment to remove the low volatile components from the fibers and thereby increase the yield of the activation process. During this carbonization treatment, the fibers are heated in an inert gas such as nitrogen to a temperature of between about 350° C. and 1000° C., and preferably between about 700° C. and 900° C. Furthermore, in order to increase the activation yield and achieve a suitable pore distribution in the activated carbon fibers, the carbon fibers are ideally milled prior to activation to a mean particle size of between about 5 and 50 micrometers, and optimally to around 25 micrometers.

The milled carbon fibers are then activated to create activated carbon fibers having a BET specific surface area of approximately 300 m²/g or larger. According to U.S. Pat. No. 6,118,650, the activation treatment involves mixing the milled carbon fibers with an alkali metal compound and then heating the mixture to react the alkali metal with the carbon fibers. For example, an amount of potassium hydroxide equal to about 0.5 to 5 times the weight of the milled carbon fibers is mixed with the fibers, and the mixture is heated in an inert gas such as nitrogen to a temperature of between approximately 500° C. to 900° C. for up to about 10 hours. The reaction product is then cooled to room temperature and rinsed with water to remove the unreacted potassium hydroxide from the activated carbon fibers.

According to the present invention, a carbon or graphitic foam product having a relatively high specific surface area is produced by mixing a first portion of the activated first carbon precursor with a second portion of a second, un-activated carbon precursor and then foaming the resulting mixture. Although not required, the second carbon precursor is preferably the same as the first carbon precursor. Thus, following on the example discussed above, the second carbon precursor ideally comprises the same mesophase pitch particles from which the activated first carbon precursor particles are derived. Also, the size of the second carbon precursor particles is optimally approximately the same as or less than the size of the first carbon precursor particles. In addition, as the proportion of the activated first carbon precursor particles is increased, the specific surface area of the resulting foam product will also increase. However, as the proportion of the activated first carbon precursor particles is increased, the mechanical strength of the resulting foam product will decrease. Thus, the first portion of the activated first carbon precursor particles preferably comprises between about 20% and 80% by weight of the mixture of the activated first and the second carbon precursor particles. More preferably, the first portion of the activated first carbon precursor particles comprises between about 40% and 60% by weight of the mixture of the activated first and the second carbon precursor particles. Furthermore, a graphitic foam product having a superior specific surface area and a suitable mechanical strength is achieved when the first portion of the activated first carbon precursor particles is about 50% by weight of the mixture of the activated first and the second carbon precursor particles.

The mixture of the activated and un-activated carbon precursor particles may be foamed using a variety of foaming methods. However, since the activated carbon precursor particles tend to inhibit effective foaming using the conventional pressure-release technique, the mixture of the activated and un-activated carbon precursor particles is preferably foamed using the method described in U.S. Pat. No. 6,033,506, which is hereby incorporated herein by reference. Accordingly, the mixture of the activated and un-activated carbon precursor particles is placed in a suitable sealable container, such as an aluminum or stainless steel container having an internal volume of a size and shape desired for the resulting foam product. If required, a mold release agent such as Boron nitride may be applied to the inside of the container to facilitate the removal of the foam product.

The container is ideally evacuated to less than about 1 torr to remove any impurities, and the mixture is then heated to a temperature of between about 50° C. and 100° C. above the temperature at which the mixture begins to soften, which for the Mitsubishi AR mesophase pitch discussed above is about 285° C. This will coalesce the mixture into a molten or liquid state. However, the activated carbon precursor particles will generally not melt at this temperature. Instead, these solid particles will fuse with and remain suspended in the molten second carbon precursor.

After the mixture is thus coalesced, the vacuum is released and an inert gas such as nitrogen is introduced to pressurize the container to up to about 1000 psi. The mixture is then gradually heated under pressure to a temperature sufficient to coke the mixture, which depending on the first and second carbon precursors is between about 500° C. and 1000° C. and for the Mitsubishi AR mesophase pitch is between about 600° C. and 800° C. During this step, the mixture is preferably heated at a rate of between about 2° C. and 5° C. per minute, and the coking temperature is ideally held for at least 15 minutes to achieve an assured soak. As the temperature of the molten mixture rises through a specific range, for example 400° C. to 500° C., the volatile gases within the mixture will evolve and thereby foam the mixture. The further heating of the mixture will then coke the foam and thus produce a solid foam product. Once the foam is coked, it is allowed to gradually cool to room temperature and the pressure within the container is slowly reduced to atmospheric pressure. During this step, the foam is preferably cooled at a rate of approximately 1.5° C. per minute to avoid imparting thermal stresses to the foam. In addition, the pressure is ideally released at a rate of approximately 2 psi per minute to prevent any remaining volatile components within the foam from rapidly expanding and potentially fracturing the foam.

The foam may then be converted to a carbon foam by heating it under an inert gas to a temperature and for a length of time sufficient to carbonize the foam. For example, the foam may be heated under nitrogen to a temperature of between about 900° C. and 1100° C. for approximately 1 hour.

Since carbon foams have thermal conductivities which are too low for most thermal management applications, the carbon foam is preferably graphitized for use in such applications. The carbon foam produced in accordance with the present invention may be converted to a graphitic foam by heating it in an inert atmosphere to a temperature and for a length of time sufficient to graphitize the foam. For example, the foam may be heated under Argon to a temperature of between about 2000° C. and 3000° C. for up to about 2 hours. In the embodiment of the invention in which Mitsubishi AR mesophase pitch is employed as the first and second carbon precursors, the carbon foam may be effectively graphitized by heating it in an inert atmosphere at around 2500° C. for approximately 2 hours. In both the carbonization and graphitization heat treatments, the temperature should be increased to the final temperature at an appropriate rate to avoid thermally stressing the foam.

It should be recognized that, while the present invention has been described in relation to the preferred embodiments thereof, those skilled in the art may develop a wide variation of procedural details without departing from the principles of the invention. Therefore, the appended claims are to be construed to cover all equivalents falling within the true scope and spirit of the invention.

What is claimed is:

1. A process for producing graphitic foam comprising:
mixing a first amount of an activated first carbon precursor with a second amount of a second carbon precursor;
heating the mixture of the activated first and the second carbon precursors to a temperature sufficient to coalesce the mixture into a liquid;
foaming the mixture;
heating the foam under an inert atmosphere to a temperature and for a length of time sufficient to carbonize the foam; and
heating the carbonized foam under an inert atmosphere to a temperature and for a length of time sufficient to graphitize the foam.

2. The process of claim 1, wherein the first carbon precursor comprises a mesophase pitch.

3. The process of claim 2, wherein the second carbon precursor comprises a mesophase pitch which is similar to the first carbon precursor.

4. The process of claim 1, wherein the first amount of the activated first carbon precursor is approximately 20% to 80% by weight of the mixture of the activated first and the second carbon precursors.

5. The process of claim 4, wherein the first amount of the activated first carbon precursor is approximately 40% to 60% by weight of the mixture of the activated first and the second carbon precursors.

6. The process of claim 5, wherein the first amount of the activated first carbon precursor is approximately 50% by weight of the mixture of the activated first and the second carbon precursors.

7. The process of claim 1, wherein the foaming step comprises:
placing the mixture of the activated first and the second carbon precursors in a sealable container;
heating the mixture to a temperature sufficient to coalesce the mixture into a liquid state;
pressurizing the container with an inert gas to up to about 1000 psi;
heating the mixture to a temperature sufficient to cause gases within the mixture to evolve and foam the mixture; and
heating the mixture to a temperature sufficient to coke the foamed mixture.

8. A process for producing a carbon foam product comprising:
obtaining a first amount of a first carbon precursor;
obtaining a second amount of a second carbon precursor;
activating the first amount of the first carbon precursor;
mixing the first amount of the activated first carbon precursor with the second amount of the second carbon precursor;
heating the mixture to a temperature sufficient to coalesce the mixture into a liquid;
foaming the mixture; and
heating the foam under an inert atmosphere to a temperature and for a length of time sufficient to carbonize the foam.

9. The method of claim 8, further comprising heating the carbonized foam under an inert atmosphere to a temperature and for a length of time sufficient to graphitize the foam.

10. The process of claim 8, wherein the first carbon precursor comprises a mesophase pitch.

11. The process of claim 10, wherein the second carbon precursor comprises a mesophase pitch which is similar to the first carbon precursor.

12. The process of claim 8, wherein the first amount of the activated first carbon precursor is approximately 20% to 80% by weight of the mixture of the activated first and the second carbon precursors.

13. The process of claim 12, wherein the first amount of the activated first carbon precursor is approximately 40% to 60% by weight of the mixture of the activated first and the second carbon precursors.

14. The process of claim 13, wherein the first amount of the activated first carbon precursor is approximately 50% by weight of the mixture of the activated first and the second carbon precursors.

15. The process of claim 8, wherein the foaming step comprises:
placing the mixture of the activated first and the second carbon precursors in a sealable container;
heating the mixture to a temperature sufficient to coalesce the mixture into a liquid state;
pressurizing the container with an inert gas to up to about 1000 psi;
heating the mixture to a temperature sufficient to cause gases within the mixture to evolve and foam the mixture; and
heating the mixture to a temperature sufficient to coke the foamed mixture.

16. A graphitic foam product which is produced from a mixture a first amount of an activated first carbon precursor and a second amount of a second carbon precursor.

17. The graphitic foam product of claim 16, wherein the first carbon precursor comprises a mesophase pitch.

18. The graphitic foam product of claim 17, wherein the second carbon precursor comprises a mesophase pitch which is similar to the first carbon precursor.

19. The graphitic foam product of claim 16, wherein the first amount of the activated first carbon precursor is approximately 20% to 80% by weight of the mixture.

20. The graphitic foam product of claim 19, wherein the first amount of the activated first carbon precursor is approximately 40% to 60% by weight of the mixture.

21. The graphitic foam product of claim 20, wherein the first amount of the activated first carbon precursor is approximately 50% by weight of the mixture.
